(19) United States
(12) Patent Application Publication
(10) Pub. No.: US 2022/0269907 A1
(43) Pub. Date: Aug. 25, 2022

(54) SYSTEMS AND METHODS FOR PROVIDING PLUG-AND-PLAY FRAMEWORKS FOR TRAINING MODELS USING SEMI-SUPERVISED LEARNING TECHNIQUES

(71) Applicant: Walmart Apollo, LLC, Bentonville, AR (US)

(72) Inventors: Binwei Yang, Milpitas, CA (US); Alessandro Magnani, Menlo Park, CA (US); Behzad Ahmadi, San Jose, CA (US)

(73) Assignee: Walmart Apollo, LLC, Bentonville, AR (US)

(21) Appl. No.: 17/183,766

(22) Filed: Feb. 24, 2021

(51) Int. Cl. G06K 9/62; G06N 3/08; G06F 9/54

(52) U.S. Cl. CPC G06K 9/6259; G06K 9/6262; G06N 3/08; G06F 9/547

(57) ABSTRACT

Systems and methods including one or more processors and one or more non-transitory storage devices storing computing instructions configured to run on the one or more processors and perform acts of providing a semi-supervised learning abstraction model that includes an API; receiving, via the API, pre-training parameters at least identifying (a) a first set of unlabeled images and (b) an encoder model selected from the plurality of encoder models; executing a pre-training procedure that trains the encoder model using the first set of unlabeled images; receiving, via the API, supervised training parameters at least identifying (a) a second set of labeled images and (b) the encoder model that is pre-trained using the pre-training procedure; executing a supervised training procedure that further trains the encoder model using the second set of labeled images; and storing a encoder model checkpoint for the encoder model. Other embodiments are disclosed herein.

### TECHNICAL FIELD

This disclosure relates generally to a plug-and-play framework that enables neural network encoding models, as well as other learning models, to be quickly trained and deployed using semi-supervised learning (SSL) techniques.

### BACKGROUND

Many electronic platforms permit users to browse, view, purchase, and/or order items (e.g., products and/or services) via the electronic platforms. Providers of electronic platforms often desire to incorporate various artificial intelligence (AI) functions into the electronic platforms for various reasons. For example, AI functions can be used to enhance the functionality, features, and/or content on the electronic platform, or enhance users' experiences on the electronic platform.

Various technical challenges arise with respect to implementing the AI functions on electronic platform. One technical challenge relates to compiling adequate training data (e.g., labeled training images) that can be used for training underlying models that facilitate performance of the AI functions. Generating a sufficient collection of training data for specific AI functions is not practical in many cases because it traditionally involves human analysis and manual annotation of large collections of images.

Another challenge that hinders the deployment of AI functions relates to the lack of reusability of training efforts across different AI functions. A model that is trained to perform a specific task (e.g., a specific classification and/or object detection task) often cannot be recycled or used for other tasks.

For these and other reasons, implementing a single AI function on the electronic platform can be difficult and time-consuming, and traditionally requires a significant investment in training resources and machinery.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a representative block diagram of a portion of the system of FIG. 3 according to certain embodiments;

FIG. 5 illustrates a flowchart for a method according to certain embodiments; and

FIG. 6 is a block diagram illustrating exemplary user-specified input parameters according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and perform functions of: providing a semi-supervised learning (SSL) abstraction model that includes an application programming interface (API), wherein the API is configured to access an encoder library comprising a plurality of encoder models and to collect user-specified input parameters used to facilitate training of the plurality of encoder models; receiving, via the API, pre-training parameters at least identifying (a) a first set of unlabeled images and (b) an encoder model selected from the plurality of encoder models; executing a pre-training procedure that trains the encoder model using the first set of unlabeled images; receiving, via the API, supervised training parameters at least identifying (a) a second set of labeled images and (b) the encoder model that is pre-trained using the pre-training procedure; executing a supervised training procedure that further trains the encoder model using the second set of labeled images; and storing a encoder model checkpoint for the encoder model after the supervised training procedure is executed, wherein the encoder model checkpoint can be accessed to facilitate performance of one or more artificial intelligence (AI) functions.

Various embodiments include a method. The method can be implemented via execution of computing instructions configured to run at one or more processors and configured to be stored at non-transitory computer-readable media The method can comprise: providing a semi-supervised learning (SSL) abstraction model that includes an application programming interface (API), wherein the API is configured to access an encoder library comprising a plurality of encoder models and to collect user-specified input parameters used to facilitate training of the plurality of encoder models; receiving, via the API, pre-training parameters at least identifying (a) a first set of unlabeled images and (b) an encoder model selected from the plurality of encoder models; executing a pre-training procedure that trains the encoder model using the first set of unlabeled images; receiving, via the API, supervised training parameters at least identifying (a) a second set of labeled images and (b) the encoder model that is pre-trained using the pre-training procedure; executing a supervised training procedure that further trains the encoder model using the second set of labeled images; and storing a encoder model checkpoint for the encoder model after the supervised training procedure is executed, wherein the encoder model checkpoint can be accessed to facilitate performance of one or more artificial intelligence (AI) functions.

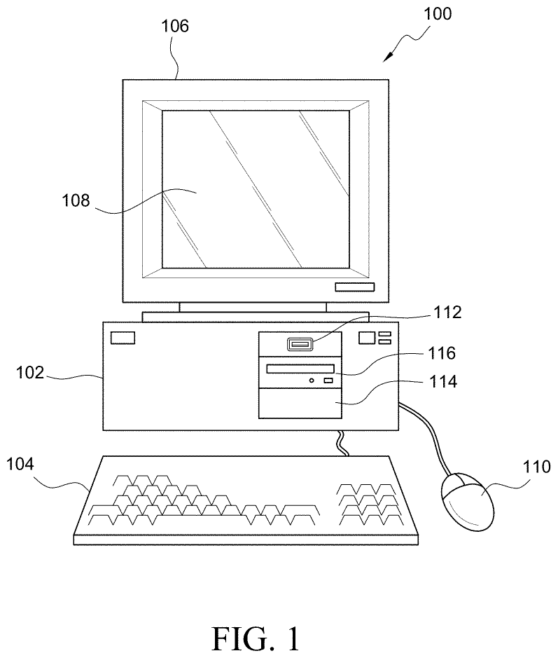

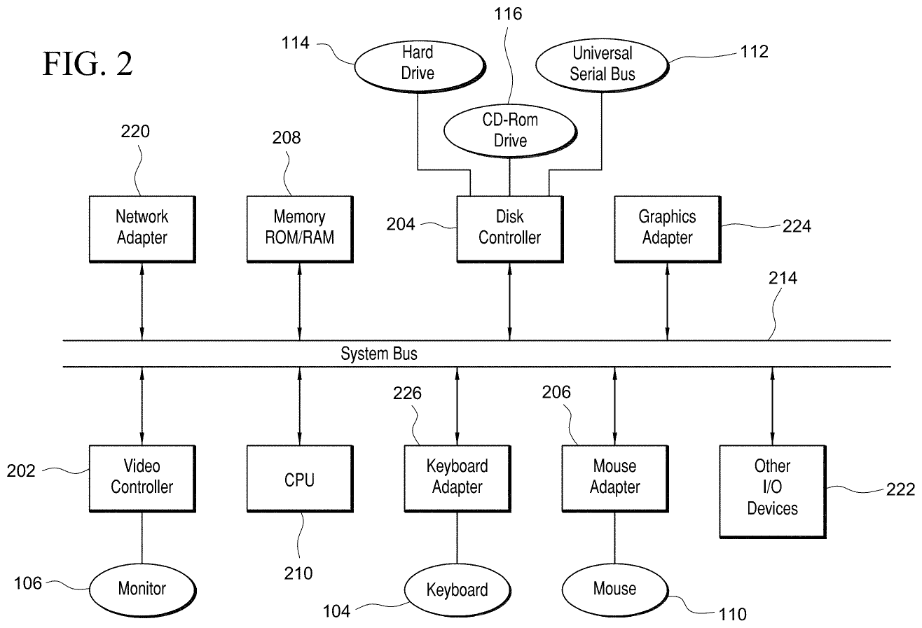

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

AIternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein. Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

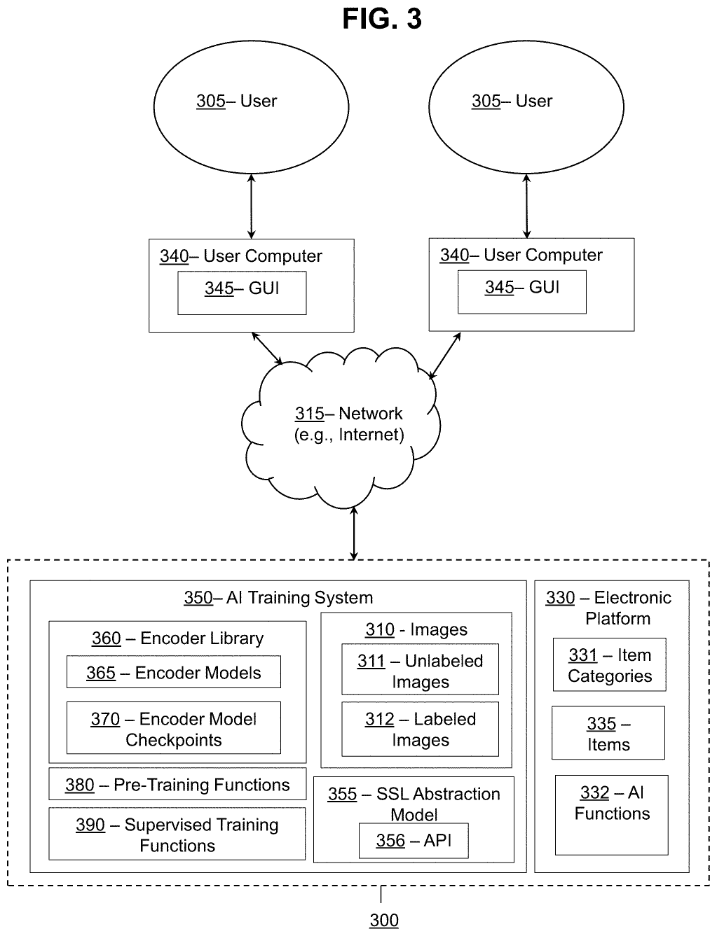

Turning ahead in the drawings, FIG. 3 illustrates a block diagram of a system 300 that can be employed for a plug-and-play framework for training models using semi-supervised learning techniques, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include an electronic platform 330 and an artificial intelligence (AI) training system 350. Electronic platform 330 and AI training system 350 can each be a computer system, such as computer system 100 (FIG. 1), as described above, and can each be a single computer, a single server, or a cluster or collection of computers or servers, or a cloud of computers or servers. In another embodiment, a single computer system can host each of the electronic platform 330 and AI training system 350. Additional details regarding electronic platform 330 and AI training system 350 are described herein.

In many embodiments, system 300 also can comprise user computers 340.

User computers 340 can comprise any of the elements described in relation to computer system 100. In some embodiments, user computers 340 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset AIliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, FIex™ product, Charge™ product, Surge™ product, or similar product by Fitbit Inc. of San Francisco, Calif., United States of America.

In many embodiments, system 300 can comprise graphical user interfaces (“GUIs”) 345. In the same or different embodiments, GUIs 345 can be part of and/or displayed by computing devices associated with system 300 and/or user computers 340, which also can be part of system 300. In some embodiments, GUIs 345 can comprise text and/or graphics (images) based user interfaces. In the same or different embodiments, GUIs 345 can comprise a heads up display (“HUD”). When GUIs 345 comprise a HUD, GUIs 345 can be projected onto glass or plastic, displayed in midair as a hologram, or displayed on monitor 106 (FIG. 1). In various embodiments, GUIs 345 can be color or black and white. In many embodiments, GUIs 345 can comprise an application running on a computer system, such as computer system 100, user computers 340, and/or one or more server computers (e.g., one or more server computers that host system 300). In the same or different embodiments, GUI 345 can comprise a website accessed through network 315 (e.g., the Internet). In some embodiments, GUI 345 can comprise an eCommerce website. In the same or different embodiments, GUI 345 can be displayed as or on a virtual reality (VR) and/or augmented reality (AR) system or display.

In some embodiments, a web server can be in data communication through network 315 (e.g., the Internet) with user computers (e.g., 340). In certain embodiments, the network 315 may represent any type of communication network, e.g., such as one that comprises the Internet, a local area network (e.g., a Wi-Fi network), a personal area network (e.g., a Bluetooth network), a wide area network, an intranet, a cellular network, a television network, and/or other types of networks. In certain embodiments, user computers 340 can be desktop computers, laptop computers, smart phones, tablet devices, and/or other endpoint devices. The web server can host one or more websites. For example, the web server can host an eCommerce website that allows users to browse and/or search for products, to add products to an electronic shopping cart, and/or to purchase products, in addition to other suitable activities.

In many embodiments, electronic platform 330 and AI training system 350 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of electronic platform 330 and AI training system 350 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of electronic platform 330 and AI training system 350. In a similar manner, the processing module(s) and the memory storage module(s) can be local and/or remote to each other.

In many embodiments, electronic platform 330 and AI training system 350 can be configured to communicate with one or more user computers 340. In some embodiments, user computers 340 also can be referred to as customer computers. In some embodiments, electronic platform 330 and AI training system 350 can communicate or interface (e.g., interact) with one or more customer computers (such as user computers 340) through a network 315 (e.g., the Internet). Network 315 can be an intranet that is not open to the public. Accordingly, in many embodiments, electronic platform 330 and AI training system 350 (and/or the software used by such systems) can refer to a back end of system 300 operated by an operator and/or administrator of system 300, and user computers 340 (and/or the software used by such systems) can refer to a front end of system 300 used by one or more users 305, respectively. In some embodiments, users 305 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, electronic platform 330 and AI training system 350 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). AIso, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

Meanwhile, communication between electronic platform 330 and AI training system 350, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

In certain embodiments, users 305 may operate user computers 340 to browse, view, purchase, and/or order items 335 via the electronic platform 330. For example, the electronic platform 330 may include an eCommerce website that enables users 305 to access interfaces displaying details about items 335, add items 335 to a digital shopping cart, and purchase the added items 335. The items 335 made available via the electronic platform 330 may generally relate to any type of product and/or service including, but not limited to, products and/or services associated with apparel, kitchenware, entertainment, furniture, fashion, appliances, sporting goods, electronics, software, etc.

The electronic platform 330 may store taxonomy information associated with classifying the items 335 that are offered through the electronic platform 330. For example, the taxonomy information can include a hierarchy of item categories 331, and each item 335 included in an online catalog can be associated with one or more of the item categories 331. High-level item categories 331 may include broad labels such as “Beauty,” “Clothing, Shoes, & Accessories,” “Sports & Outdoors,” etc. One or more lower-level item categories 331 may segment each of the high-level item categories 331 into more specific categories. In some cases, the lower-level item categories 331 can include product-specific and/or service-specific categories. Examples of lower level item categories 331 within a broad “Electronics” category can include categories associated with labels such as “TVs,” “cell phones,” “tablets,” etc. Each item 335 offered by the electronic platform 330 can be assigned to, or associated with, one or more item categories 331, including one or more high-level categories and/or one or more product-specific or service-specific categories.

In many embodiments, numerous artificial intelligence (AI) functions 332 can be utilized to enhance the functionality, features, content, and/or user experience associated with electronic platform 330. An AI function 332 can include any function that utilizes, or is associated with, one or more machine learning models and/or one or more artificial neural networks (e.g., networks that are configured to execute deep learning functions).

The functions performed by the AI functions 332 can vary greatly. Some of the AI functions 332 can analyze images 310 included on the electronic platform 330 to enhance the functionality, features, and/or user experience associated with electronic platform 330. For example, in some cases, an AI function 332 can be configured to analyze the images 310 associated with items 335 to supplement the metadata associated with the items 335. In other examples, an AI function 332 can be configured to analyze images 310 associated with items 335 to perform visual similarity searches. In some cases, visual similarity searches can be performed to ensure the images 310 do not include non-compliant content (e.g., nudity, vulgarity, racially-insensitive content, offensive content, inappropriate logos, etc.), and/or to remove or restrict access to images 310 that violate policies associated with a provider of an electronic platform 330. In performing these and other functions that involve analysis of image content, the AI functions 332 can be configured to perform various computer vision functions such as object detection, objection classification, instance segmentation, etc.

In further examples, the AI functions 332 can be used to recommend items 335 to users 305, predict preferences or affinities of users 305, and enhance functionality of various features (e.g., interfaces, digital shopping carts, order placement and scheduling systems, etc.) on the electronic platform 330. The AI functions 332 can be configured to perform may other useful functions as well.

The configurations of the AI functions 332 can vary, and their configurations can be adapted to their intended functionality. In certain embodiments, the AI functions 332 can be implemented using one or more neural network models that are configured and/or trained to classify images 310 (and/or objects included in images 310) and/or detect target objects included the images 310. In some cases, the neural network models can be implemented as convolutional neural networks (CNNs).

In some embodiments, each neural network model can be configured to analyze images 310 and execute deep learning functions and/or machine learning functions on the images 310. Each neural network model can include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more detection layers, one or more upsampling layers, one or more normalization layers, etc. The configurations of the neural network models and their corresponding layers enable the neural network models to learn and execute various functions for analyzing, interpreting, and understanding the content of the images 310. The functions learned by the neural network models, or other neural network structures, can include computer vision functions that involve classification and/or object detection functions.

Various technical challenges arise with respect to implementing the AI functions 332 on electronic platform 330. For example, with respect AI functions 332 that involve analysis of image content, one technical challenge relates to compiling adequate training data (e.g., training images) that can be used to train underlying models (e.g., encoder models 365) that are used to perform the AI functions 332. In many cases, the electronic platform 330 may have access to large collections of images 310 (e.g., millions of images that are associated with the items 335). However, these images 310 are often unlabeled images 311 that do not include ground-truth labels (e.g., labels, bounding boxes, instance segmentation annotations, etc.) and/or do not include ground-truth labels for specific training tasks (e.g., for specific object detection and/or classification tasks that are desired on the electronic platform 330). Moreover, generating a sufficient collection of labeled images 312 (e.g., images that include ground-truth labels) for specific training tasks is often not practical because, in many cases, it typically involves human analysis and manual annotation of large collections of images 310 (e.g., tens or hundreds of thousands of images).

Another challenge that hinders the deployment of AI functions 332 on electronic platforms 330 is the time-consuming and resource-intensive nature associated with training their underlying models. For example, various models can include an encoder model 365, which is trained to generate embeddings from images that can be used to performing classification functions, object detection functions, and/or other computer vision functions. Regardless of the training technique employed, users can spend significant time configuring the underlying models and training procedures in addition to the significant amount of time required for actually executing the training procedures.

Another challenge that hinders the deployment of AI functions 332 on electronic platforms 330 is that that their underlying models (e.g., underlying neural network and/or machine learning models) are not trained in manner than enables the models to be reused across multiple AI tasks. Rather, a model that is trained to perform a specific task (e.g., a specific classification and/or object detection task) using traditional techniques is often built specifically for that task, and the training efforts expended for that task cannot be recycled or used for other tasks.

For these and other reasons, implementing a single AI function 332 on the electronic platform 330 can be difficult and time-consuming, and traditionally requires a significant investment in training resources and machinery.

To address these and other challenges, an AI training system 310 provides a plug-and-play framework for training encoder models 365 and/or other models used to perform AI functions 332. The AI training system 310 minimizes the time, training resources, and machinery required to train the models that perform AI functions 332. As explained further below, this plug-and-play framework stores various models in a library, and permits users to easily select the desire models to be trained while minimizing the time typically required to setup and configure the models. Additionally, the plug-and-play framework enables storage of checkpoints during various stages of the training operations. These checkpoints be reused for various training tasks, thus permit users to recycle previous efforts expended on training.

Due to the limited availability of labeled training images in many cases, the AI training system 310 can utilize semi-supervised training techniques (e.g., which may include a first pre-training stage using unlabeled data and a subsequent supervised training stage using labeled data) to train the models. In certain embodiments, the AI training system 310 enables large collections of unlabeled images 311 available on the electronic platform 330 to be leveraged in early training stages of the models, thereby reducing the quantity of labeled images 312 needed for training.

The configuration of the AI training system 310, as well as the training techniques facilitated by the AI training system 310, can vary. In certain embodiments, the AI training system 310 at least includes a semi-supervised learning (SSL) abstraction model 355, an encoder library 360 comprising a plurality of encoder models 365, and an application programming interface (API) 356 that enables the SSL abstraction model 355 to access, configure, and execute the encoder models 365 included in the encoder library 360. Each of these components are described in further detail below.

In certain embodiments, the SSL abstraction model 355 can be used to facilitate training of encoder models 365 (and/or other learning models). The SSL abstraction model 355 provides an abstraction for executing semi-supervised training procedures, which utilize both unlabeled images 311 and labeled images 312 to train the encoder models 365. The SSL abstraction model 355 enables users to easily and conveniently select any of the pre-stored encoder models 365 included in the encoder library 360 for training, and to identify training images that can be used in pre-training and supervised training stages. In some cases, the SSL abstraction model 355 further permits the users to specify and/or configure hyperparameters to be used in both the pre-training and supervised training stages. An API 356 of the SSL abstraction model 355 receives parameters specified by a user, and automatically configures the designated encoder models 365 and training procedures based on the specified parameters.

The encoder library 360 stores a plurality of encoder models 365. In certain embodiments, each encoder model 365 may represent a neural network model and/or machine-learning model that is configured to generate or encode embeddings (e.g., feature vectors) for images that are received by the encoder model 365. The embeddings derived from the images can then be utilized to perform various downstream AI functions 332 (e.g., such as tasks related to classification, object detection, etc.).

The types of encoder models 365 included in the encoder library 360 can vary, and generally can include any type of encoding mechanism. Exemplary encoder models 365 can include neural network models, such as ResNet (Residual Neural Network), DenseNet (Dense Convolutional Network), EfficientNet, and/or any other suitable convolutional neural networks. The encoder models 365 also may include custom or proprietary encoder models 365. Other types of encoder models 365 (and/or other models) also can be included in the encoder library 360.

The configurations of the encoder models 365 can vary. In certain embodiments, the encoder models 365 can be configured with one or more convolutional layers, including one or more input layers, one or more output layers, and one or more hidden layers that connected the input and output layers. In certain embodiments, the encoder models 365 can be configured as multilayer perceptron (MLP) encoders. Other configurations of encoder models 365 also may be used.

When users desire to implement or deploy new AI functions 332 (e.g., on the electronic platform 330), the SSL abstraction model 355 can permit the users to quickly execute pre-training functions 380 and supervised training functions 390 for training one or more desired encoder models 365. In certain embodiments, the API 356 of the SSL abstraction model 355 is configured to access the encoder library 360, and utilize parameters specified by a user to execute the pre-training functions 380 and supervised training functions 390 on selected encoder models 365.

For example, the SSL abstraction model 355 may permit a user to identify or select an encoder model 365 from the encoder library 360 for training, and to identify or select sets of unlabeled images 311 and labeled images 312 to be used for performing pre-training functions 380 and supervised training functions 390, respectively, on the selected encoder model 365. In some cases, the SSL abstraction model 355 also may permit a user to identify hyperparameters and/or other settings for the pre-training functions 380 and supervised training functions 390. The API 356 may receive these selections provided by the user, and utilize the selections to configure and execute the training function the selected encoder model 365. In this manner, the SSL abstraction model 355 minimizes the time required to setup, configure, and/or install the encoder models 365, as well as the time to configure the training schemes for encoder models 365. The abstraction layer provided by the SSL abstraction model 355 can handle some or all of these tasks for the user.

In certain embodiments, to execute a pre-training function 380 on an encoder model 365, the SSL abstraction model 355 can permit a user to designate an encoder model 365 to be pre-trained, and to designate a collection of unlabeled images 311 for pre-training the encoder model 365. The API 356 of the SSL abstraction model 355 can utilize these selections to initiate the pre-training function 380. For example, in some cases, the API 356 may create a new instance of the selected encoder model 365, configure the selected encoder model 365 to utilize the identified collection of unlabeled images 311, and/or configure hyperparameters of the pre-training procedure 380 (e.g., either using default hyperparameters and/or custom hyperparameters specified by the user).

In many cases, the pre-training function 380 refines or configures the weights (and/or other settings) associated with selected encoder models 365 to learn global features associated with images. These global features may represent the visual content of images as a whole. The pre-training function 380 can enable the encoder models 365 to generate embeddings (e.g., feature vectors) that more accurately capture these global features. SimCLR, BYOL and SwAV are examples of pre-training functions 380 supported by the AI training system 350. The framework expanded these methods so they can be used with any suitable encoder models 365.

Similarly, the SSL abstraction model 355 can abstract the performance of supervised training functions 390 by allowing a user to designate an encoder model 365 (e.g., in some cases, the encoder model 365 that was pre-trained) for training, a collection of labeled images 312 for training the designated encoder model 365, and/or hyperparameters for the supervised training functions 390. Again, the API 356 of the SSL abstraction model 355 can utilize these selections to initiate the supervised training functions 390. For example, in some cases, the API 356 may create a new instance of the selected encoder model 365, configure the selected encoder model 365 to utilize the identified collection of labeled images 312, and/or configure hyperparameters for the supervised training functions 390 (e.g., either using default hyperparameters and/or hyperparameters specified by the user via the abstraction model 355).

The supervised training function 390 configures the weights (and/or other settings) associated with selected encoder models 365 to learn salient features associated with images. These salient features may represent the local visual content and/or objects that are the focus of the images. The supervised training function 390 can enable the encoder models 365 to generate embeddings (e.g., feature vectors) that more accurately capture these local and/or salient features.

In certain embodiments, large collections of unlabeled images 311 available on the electronic platform 330 can be leveraged during pre-training to more accurately train a designated encoder model 365 to learn the global features associated with images. That is, the particular unlabeled images 311 used for pre-training can be specifically selected for a particular task or intended AI function 332 that is being developed.

Consider an example in which a user desires to implement an AI function 332 that is able to supplement metadata associated with apparel items 335 (e.g., T-shirts or dresses) with indicators that identify a particular pattern (e.g., striped, solid, polka dot, etc.) included on the apparel items 335. In this example, a collection of unlabeled images 311 can be compiled and/or retrieved from an item category 331 that includes apparel items 335, and these unlabeled images 311 can be used to pre-train a selected encoder model 365. Because the unlabeled images 311 are not random (and include content that is directly related to the desired specific task or intended AI function 332), the encoder model 365 can more accurately learn the features of images and better refine the weights of the encoder model 365. Because the encoder model 365 is optimized in this fashion during the early stages of training, subsequent training stages may require less labeled images 312 to finalize the training of the encoder model 365. As mentioned above, this can be advantageous because compiling large collections of labeled images 312 can be time-consuming and expensive, and sufficient collections of labeled images 312 are often not available.

The manner in which the SSL abstraction model 355 and/or API 356 collects the designations, selections, and/or inputs (e.g., identifying encoder models 365, training images, and/or hyperparameters) from users can vary. In certain embodiments, one or more GUIs 345 can be built on top of the SSL abstraction model 355 to collect the designations and parameters for configuring the performance of the training functions (including the pre-training functions 380 and supervised training functions 390). Additionally, or alternatively, these designations and parameters can be specified by simply adjusting variables in the source code used to implement the SSL abstraction model 355 and/or API 356. In either case, the effort and time to configure and train the encoder models 365 is significantly reduced.

At various points during the pre-training and supervised training stages, encoder model checkpoints 370 can be saved and/or stored in the encoder library 360 for each of the encoder models 365. For example, after a pre-training function 380 is performed on an encoder model 365, an encoder model checkpoint 370 can be stored that captures or indicates the state of the encoder model 365 (e.g., the state of an underlying algorithms, weights, variables, and/or settings associated with the encoder model 365). As explained above, the state of the encoder model 365 after pre-training can reflect refined weights and settings that enable the encoder model 365 to understand global features of images. In some cases, specifically selected unlabeled images 311 that were used to pre-train the encoder model 365 can optimize the state of the encoder model 365 to understand these features for particular tasks with greater accuracy and precision

Similarly, after a supervised training function 390 is performed on an encoder model 365, an encoder model checkpoint 370 can be saved and/or stored that captures or indicates the state of the encoder model 365 (e.g., the state of an underlying algorithm, weights, variables, and/or settings associated with the encoder model 365). The state of the encoder model 365 after supervised training can reflect refined weights and settings that enable the encoder model 365 to understand salient and/or local features of images.

Over time, more and more encoder model checkpoints 370 can be added to the encoder library 360. These encoder model checkpoints 370 can be subsequently accessed to significantly reduce training time, machinery, and resources for developing and deploying other AI functions 332.

The encoder model checkpoints 370 derived from the encoder models 365 after pre-training can be loaded to initialize encoder models 365 before supervised training is performed. In various scenarios, when a new task or AI function 332 is desired, a user can reuse or recycle a previously created encoder model checkpoint 370, thus saving the time and resources associated with pre-training. For example, consider the above scenario involving an AI function 332 that supplements the metadata of apparel items based on the pattern content in corresponding images for the items. Because one or more encoder models 365 can be pre-trained using a particular subset of unlabeled images 311 (e.g., from a particular item category 311), any encoder model checkpoints 370 derived on these images can be utilized for other tasks that can benefit from training on these images (e.g., other tasks that would benefit from training on apparel images).

Thus, an encoder model checkpoint 370 initially derived during pre-training to enable performance of a first AI function 332 can be used as a starting point for supervised training of the encoder model 365 for the first AI function 322, as well as one a starting point for supervised training of encoder models 365 for one or more additional AI functions 322 that may arise at a later time.

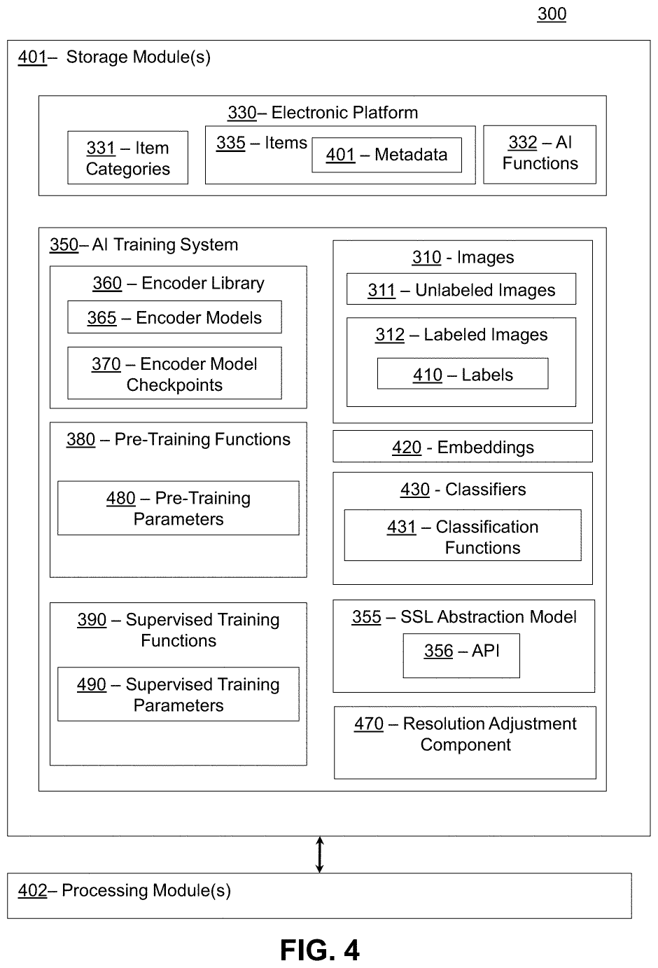

FIG. 4 is a block diagram illustrating a detailed view of an exemplary system 300 in accordance with certain embodiments. The system 300 includes one or more storage modules 401 that are in communication with one or more processing modules 402. The one or more storage modules 401 can include: (i) non-volatile memory, such as, for example, read-only memory (ROM) or programmable read-only memory (PROM); and/or (ii) volatile memory, such as, for example, random access memory (RAM), dynamic RAM (DRAM), static RAM (SRAM), etc. In these or other embodiments, storage modules 401 can comprise (i) non-transitory memory and/or (ii) transitory memory. The one or more processing modules 402 can include one or more central processing units (CPUs), graphical processing units (GPUs), controllers, microprocessors, digital signal processors, and/or computational circuits. The one or more storage modules 401 can store data and instructions associated with providing an AI training system 310 and electronic platform 330. The one or more processing modules 402 can be configured to execute any and all instructions associated with implementing the functions performed by these components. Exemplary configurations for each of these components are described in further detail below.

The exemplary electronic platform 330 of system 300 includes one or more databases. The one or more databases can store data and images 310 and metadata 401 related to items 335 (e.g., products and/or services) that are offered or made available via the electronic platform 330. For example, for each item 335, metadata 401 associated with the item 335 can include any or all of the following: an item name or title, an item category associated with the item, a price, one or more customer ratings for the item, an item description, images corresponding to the item, a number of total sales, and various other data associated with the item.

In some embodiments, the metadata 401 for an item 335 also may include feature descriptors indicating whether the item 335 includes one or more particular features. For example, in the case of apparel items, features descriptors my indicate patterns associated with the apparel items, sizes of the apparel items, colors of the apparel item, etc. In some embodiments, the AI functions 332 used to optimize the electronic platform 330 can analyze images 310 associated with items 335 to identify these feature descriptors and update the metadata 401 associated with these items 335 to include the identified feature descriptors. The AI functions 332 can be used to supplement metadata 401 in other ways as well.

Any of the images 310 available on the electronic platform and/or used for training also can be stored in the one or more databases. As explained above, the images 310 used for training can include unlabeled images 311 and labeled images 312. Each of the labeled images 312 include one or more labels 410. A label 410 may generally represent any ground-truth information associated with an image 310. In certain embodiments, the labels 410 may represent identifiers and/or text strings that identify the presence of one or more feature descriptors for the images. The labels 410 additionally, or alternatively, can include other types of annotations (e.g., bounding boxes, pixel-level segmentation, etc.). The unlabeled images 311 can represent images that do not include labels 410 and/or images that do not include labels 410 desired for specific AI tasks.

As explained above, the SSL abstraction model 355 can permit the users to quickly execute pre-training functions 380 and supervised training functions 390 for training one or more desired encoder models 365. Rather than manually configuring the encoder models 365 and training functions, the SSL abstraction model 355 enables the user to specify pre-training parameters 480 and supervised training parameters 490, which can be utilized by the API 356 to execute the pre-training functions 380 and supervised training functions 390.

The pre-training parameters 480 can generally include any inputs that can be used to select or configure an encoder model 365 for pre-training and/or any inputs that can be used to configure pre-training functions 380 for the encoder model 365. Similarly, supervised training parameters 490 can generally include any inputs that can be used to select or configure an encoder model 365 for supervised training and/or any inputs that can be used to configure supervised training functions 390 for the encoder model 365.

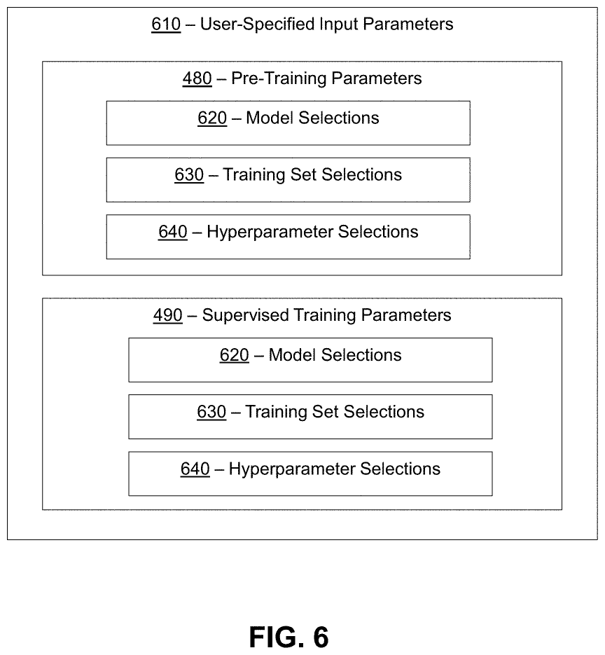

FIG. 6 is a block diagram illustrating exemplary user-specified input parameters 610 that can be included in the pre-training parameters 480 and supervised training parameters 490. Both the pre-training parameters 480 and the supervised training parameters 490 can comprise model selections 620, training set selections 630, and hyperparameter selections 640. Other types of user-specified input parameters 610 also can be received to facilitate training of encoder models.

The model selections 620 received with the pre-training parameters 480 identify one or more encoder models included in an encoder library that a user desires to train using a pre-training function (e.g., to learn global features). The training set selections 630 received with the pre-training parameters 480 identify a set of training images to be used to train the one or more identified encoder models. In certain embodiments, training images include a large collection (e.g., tens or hundreds of thousands) of unlabeled images, which, in some cases, can be retrieved from the electronic platform.

The hyperparameter selections 640 received with the pre-training parameters 480 identify hyperparameters to be utilized for the pre-training functions. In certain embodiments, the hyperparameter selections 640 can be used to configured one or more the following parameters of the pre-training functions used for each identified encoder model: an encoder model topology; an encoder model size; a learning rate; a batch size and/or mini-batch size; a number of hidden layers for the encoder model; dropout values; momentum; and/or a number of epochs. Other related parameters also can be included in the hyperparameter selections 640.

The model selections 620 received with the supervised training parameters 490 identify one or more encoder models included in an encoder library that a user desires to train using a supervised training function (e.g., to learn local and/or salient features). The training set selections 630 received with the supervised training parameters 490 identify a set of training images to be used to train the one or more identified encoder models. In certain embodiments, training images include a collection of labeled images.

The hyperparameter selections 640 received with the supervised training parameters 490 identify hyperparameters to be utilized by the supervised training functions. The hyperparameter selections 640 can be used to configure one or more the following parameters of the supervised training functions for each identified encoder model: an encoder model topology; an encoder model size; a learning rate; a batch size and/or mini-batch size; a number of hidden layers for the encoder model; dropout values; momentum; and/or a number of epochs. Other related parameters also can be included in the hyperparameter selections 640.

Returning to FIG. 4, the aforementioned and user-specified input parameters (as well as other parameters) can be collected by an abstraction layer provided by the SSL abstraction model 355. This may include collecting the aforementioned parameters via one or more GUIs and/or specifying values for variables in the source code associated with the SSL abstraction model 355. As explained above, the API 356 of the SSL abstraction model 355 uses the user-specified input parameters to configure and train the designated encoder models 365.

Additionally, in certain embodiments, a user can utilize the SSL abstraction model 355 to specify input parameters and initiate training for multiple encoder models 365 simultaneously. If the user only desires to initiate training of a single encoder model 365, the user can only include the input parameters for the desired encoder model 365.

The pre-training function 380 and supervised training function 390 enable encoder models 365 to generate embeddings 420 from images 130. Each embedding 420 may represent a feature vector and/or a representation of a corresponding in a high-dimensional space. The size of the embeddings 420 may vary (and, in some cases, may be 1408-1536, 1792, 2048 etc.). Embeddings 420 generated by the encoder models 365 after pre-training can include information that captures or represents global features of corresponding images. Embeddings 420 generated by the encoder models 365 after supervised can include information that captures or represents both global features and local features of corresponding images.

As explained above, encoder model checkpoints 370 associated with the encoder models 365 can be saved in the encoder library 360 at various points during the training process (e.g., after completion of pre-training functions 380 and/or supervised training functions 390). These encoder model checkpoints 370 capture the state of the encoder models 365 at particular times during the training process. Users can access and utilize the encoder model checkpoints 370 at any point after they are stored, thus permitting the encoder model checkpoints 370 to be used for an AI function 332 that currently is under development and for later reuse in developing other AI functions 332 that are desired in the future.

In certain embodiments, the SSL abstraction model 355, API 356, and/or other component can facilitate using of the encoder model checkpoints 370 by the AI functions 332 (and/or models associated with performing the AI functions). For example, in certain embodiments, the SSL abstraction model 355 may permit a user to identify a model associated with an AI function 332 (e.g., a classifier 430) and to identify one or more encoder model checkpoints 370 to be utilized by the model associated with an AI function 332. The AI 356 can use these selections to load the one or more encoder model checkpoints 370 into the model associated with the AI function 332.

The encoder model checkpoints 370 and/or trained encoder models 365 can be used for various AI functions 332. Some of the AI functions 332 can include classification functions 431 that are configured to classify images 310 associated with items 335 provided on the electronic platform 330 (e.g., to supplement the metadata 401 associated with the items 335). Another exemplary AI function 332 can be configured to facilitate visual similarity searches on images 310 included on the electronic platform 330 (e.g., to detect target images and/or images that include non-compliant content). The encoder model checkpoints 370 and/or trained encoder models 365 can be used for many other AI functions 332 as well.

In some embodiments, the encoder model checkpoints 370 can be utilized by, and loaded into, one or more classifiers 430. Each classifier 430 can be configured to execute one or more classification functions 431. The classification functions 431 can include any functions that involves classifying images 310, and/or objects or content included in the images 310. The classification functions 431 executed by the classifiers 430 can be utilized to assign labels 410 to the images.

In certain embodiments, the encoder model checkpoints 370 derived from encoder models 365 (e.g., after supervised training functions 390 are performed) can be loaded into, or utilized by, the classifiers 430 to test or execute classification functions 431. For example, consider the above example in which an AI function 332 is being developed to supplement metadata 401 associated with the items 335. In this scenario, a user may desire to test and evaluate performance of multiple encoder models 365, each of which generates embeddings 420 that can be used to perform classification tasks based on the settings a corresponding encoder model checkpoint 370. Therefore, each of the encoder model checkpoints 370 can be loaded into the classifier 430 to generate results for detecting labels 410 (e.g., indicating apparel patterns). For each of the encoder model checkpoints 370, the labels 410 assigned by the classifier 430 can be output to users with evaluation results (e.g., indicating the accuracy of the assigned labels 410 and/or other relevant evaluation information). The encoder model checkpoint 370 having the best performance (e.g., in terms of accuracy) can be selected to update the metadata of the items 335 provided on the electronic platform 330.

The encoder model checkpoints 370 can be loaded into, or used by, other types of models as well. For example, in certain embodiments, the encoder model checkpoints 370 can be used by models that are configured to perform object detection functions, instance segmentation functions, and/or other types of AI functions 332.

In certain embodiments, the AI training system 310 also can include a resolution adjustment component 470 that can optimize the performance classification functions 431 performed by the classifier 430 and/or account for resolution discrepancies of images used during training and inference. During pre-training of certain encoder models 365, the images (e.g., unlabeled 131) used for training may be transformed using random resize and crop functions, which produces rectangular images with random coordinates. However, at inference time, the images analyzed by the classifier 430 may be transformed using a center crop, which covers the central part of the images. Testing has shown that this resolution discrepancy can negatively influence test time performance.

To address this issue, the resolution adjustment component 470 can cause the both the selected encoder model 365 and the classifier 430 to be pre-trained on images having at a lower resolution (e.g., a resolution of 224×244). With this smaller resolution during pre-training, it is possible to save processing memory and use larger batch sizes, which ultimately produces better classification performance. Thereafter, the resolution adjustment component 470 can refine the classifier 430 by training it with images having a greater resolution (e.g., a resolution of 380×380).

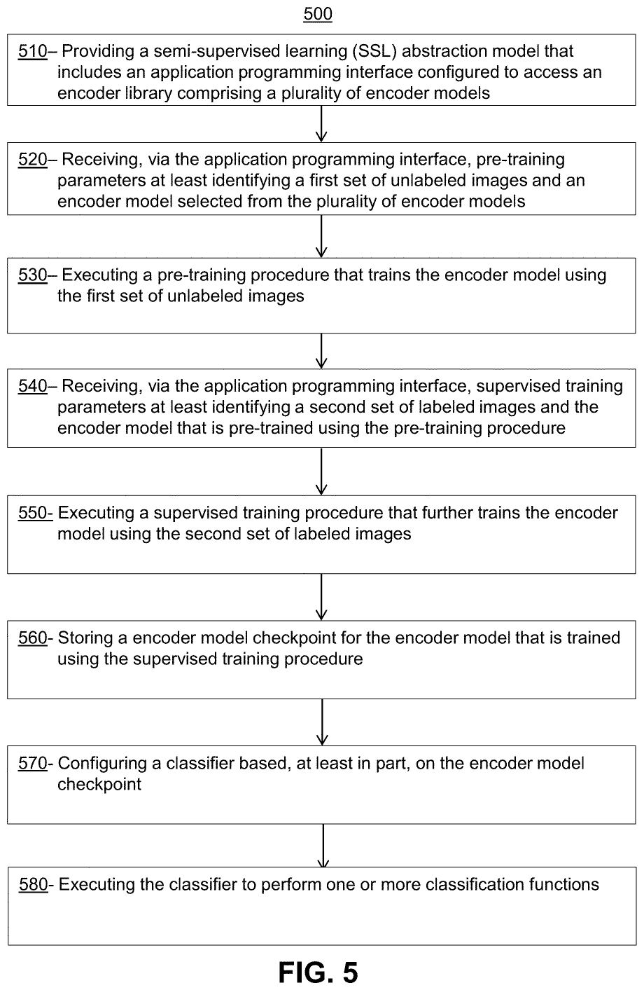

Turning ahead in the drawings, FIG. 5 illustrates a flow chart for a method 500, according to an embodiment. Method 500 is merely exemplary and is not limited to the embodiments presented herein. Method 500 can be employed in many different embodiments or examples not specifically depicted or described herein. In some embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIGS. 3-4) and/or training system 350 (FIGS. 3-4) can be suitable to perform method 500 and/or one or more of the activities of method 500. In these or other embodiments, one or more of the activities of method 700 can be implemented as one or more computer instructions configured to run at one or more processing modules 402 (FIG. 4) and configured to be stored at one or more non-transitory memory storage modules 401 (FIG. 4). Such non-transitory memory storage modules 401 (FIG. 4) can be part of a computer system such as system 300 (FIGS. 3-4) and/or training system 350 (FIGS. 3-4). The processing module(s) also can be similar or identical to the processing module(s) described above with respect to computer system 100 (FIG. 1).

In certain embodiments, method 500 can comprise an activity 510 of providing a SSL abstraction model that includes an API configured to access an encoder library comprising a plurality of encoder models.

In certain embodiments, method 500 can comprise an activity 520 of receiving, via the API, pre-training parameters at least identifying a first set of unlabeled images and an encoder model selected from the plurality of encoder models.

In certain embodiments, method 500 can comprise an activity 530 of executing a pre-training procedure that trains the encoder model using the first set of unlabeled images.

In certain embodiments, method 500 can comprise an activity 540 of receiving, via the API, supervised training parameters at least identifying a second set of labeled images and the encoder model that is pre-trained using the pre-training procedure.

In certain embodiments, method 500 can comprise an activity 550 of executing a supervised training procedure that further trains the encoder model using the second set of labeled images.

In certain embodiments, method 500 can comprise an activity 560 of storing an encoder model checkpoint for the encoder model that is trained using the supervised training procedure.

In certain embodiments, method 500 can comprise an activity 570 of configuring a classifier based, at least in part, on the encoder model checkpoint.

In certain embodiments, method 500 can comprise an activity 580 of executing the classifier to perform one or more classification functions.

As evidenced by the disclosure herein, the techniques set forth in this disclosure are rooted in computer technologies that overcome existing problems associated with training learning models, including problems associated with limited availability of labeled content and the extensive resources traditionally required to train the learning models. The techniques described in this disclosure provide a technical solution (e.g., one that provides an abstraction layer for accessing and configuring learning models and training procedures) for overcoming these obstacles. For example, the SSL abstraction model described herein provides an abstraction layer that enables encoder models and/or other models to be quickly and efficiently trained using semi-supervised learning techniques. Moreover, in certain embodiments, the techniques described herein take advantage of large collections of unlabeled images to improve pre-training of the learning models. This technology-based solution marks an improvement over existing capabilities and functionalities related to training learning models by improving the speed at which the models can be trained, and enabling refined checkpoints to be stored and reused for other tasks and purposes.

In certain embodiments, the techniques described herein can advantageously improve user experiences with electronic platforms by permitting various AI functions to be quickly deployed on electronic platforms. In many embodiments, the techniques described herein can be used continuously at a scale that cannot be reasonably performed using manual techniques or the human mind (e.g., due to the large numbers of images, and complex operations executed by the training procedures). The data analyzed by the learning models described herein can be too large to be analyzed using manual techniques.

Furthermore, in a number of embodiments, the techniques described herein can solve a technical problem that arises only within the realm of computer networks, because machine learning does not exist outside the realm of computer networks.

Although systems and methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 5 may include different procedures, processes, and/or activities and can be performed by many different modules, in many different orders.

AIl elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable storage devices storing computing instructions configured to run on the one or more processors and perform acts of:
providing a semi-supervised learning (SSL) abstraction model that includes an application programming interface (API), wherein the API is configured to access an encoder library comprising a plurality of encoder models and to collect user-specified input parameters used to facilitate training of the plurality of encoder models;
receiving, via the API, pre-training parameters at least identifying (a) a first set of unlabeled images and (b) an encoder model selected from the plurality of encoder models;
executing a pre-training procedure that trains the encoder model using the first set of unlabeled images;
receiving, via the API, supervised training parameters at least identifying (a) a second set of labeled images and (b) the encoder model that is pre-trained using the pre-training procedure;
executing a supervised training procedure that further trains the encoder model using the second set of labeled images; and
storing a encoder model checkpoint for the encoder model after executing the supervised training procedure, wherein the encoder model checkpoint can be accessed to facilitate performance of one or more artificial intelligence (AI) functions.

2. The system of claim 1, wherein:
the encoder model checkpoint is stored by an AI training system; and
the encoder model checkpoint is accessed via the AI training system and loaded into one or more classifiers to perform one or more classification functions.

3. The system of claim 1, wherein:
the first set of unlabeled images identified by the pre-training parameters are retrieved from an electronic platform;
the first set of unlabeled images include a plurality of images that are selected from one or more item categories on the electronic platform;
the first set of unlabeled images do not include labels; and
the second set of labeled images identified by the supervised training parameters include a plurality of labeled images that include labels.

4. The system of claim 3, wherein:
the API configures the pre-training procedure to use the first set of unlabeled images; and
the API configures the supervised training procedure to use the second set of labeled images.

5. The system of claim 1, wherein:
the pre-training parameters received via the API further identify one or more first hyperparameter selections to be used in the pre-training procedure; and
the supervised training parameters received via the API further identify one or more second hyperparameter selections to be used in the supervised training procedure.

6. The system of claim 5, wherein:
the API configures the pre-training procedure to use the one or more first hyperparameter selections; and
the API configures the supervised training procedure to use the one or more second hyperparameter selections.

7. The system of claim 1, wherein:
a second encoder model checkpoint is stored for the encoder model after the pre-training procedure is executed; and
the second encoder model checkpoint can be accessed, via the API, as a basis for performing a plurality of different supervised training procedures.

8. The system of claim 1, wherein:
the SSL abstraction model can permit a user to indicate user-specified input parameters for training multiple encoder models.

9. The system of claim 8, wherein:
each of the multiple encoder models are trained using the pre-training procedure and the supervised training procedure; and
a plurality of encoder model checkpoints are stored, each of which is associated with a respective one of the multiple encoder models.

10. The system of claim 1, wherein:
the one or more AI functions are configured to analyze images pertaining to items offered through an electronic platform; and
the one or more AI functions perform one or more classification functions that are utilized to supplement metadata associated with the items offered through an electronic platform.

11. A method implemented via execution of computing instructions configured to run at one or more processors and configured to be stored at non-transitory computer-readable media, the method comprising:
providing a semi-supervised learning (SSL) abstraction model that includes an application programming interface (API), wherein the API is configured to access an encoder library comprising a plurality of encoder models and to collect user-specified input parameters used to facilitate training of the plurality of encoder models;
receiving, via the API, pre-training parameters at least identifying (a) a first set of unlabeled images and (b) an encoder model selected from the plurality of encoder models;
executing a pre-training procedure that trains the encoder model using the first set of unlabeled images;
receiving, via the API, supervised training parameters at least identifying (a) a second set of labeled images and (b) the encoder model that is pre-trained using the pre-training procedure;
executing a supervised training procedure that further trains the encoder model using the second set of labeled images; and
storing a encoder model checkpoint for the encoder model after executing the supervised training procedure, wherein the encoder model checkpoint can be accessed to facilitate performance of one or more artificial intelligence (AI) functions.

12. The method of claim 11, wherein:
the encoder model checkpoint is stored by an AI training system;
the encoder model checkpoint is accessed via the AI training system and loaded into one or more classifiers to perform one or more classification functions.

13. The method of claim 11, wherein:
the first set of unlabeled images identified by the pre-training parameters are retrieved from an electronic platform;
the first set of unlabeled images include a plurality of images that are selected from one or more item categories on the electronic platform;
the first set of unlabeled images do not include labels; and
the second set of labeled images identified by the supervised training parameters include a plurality of labeled images that include labels.

14. The method of claim 13, wherein:
the API configures the pre-training procedure to use the first set of unlabeled images; and
the API configures the supervised training procedure to use the second set of labeled images.

15. The method of claim 11, wherein:
the pre-training parameters received via the API further identify one or more first hyperparameter selections to be used in the pre-training procedure; and
the supervised training parameters received via the API further identify one or more second hyperparameter selections to be used in the supervised training procedure.

16. The method of claim 15, wherein:
the API configures the pre-training procedure to use the one or more first hyperparameter selections; and
the API configures the supervised training procedure to use the one or more second hyperparameter selections.

17. The method of claim 11, wherein:
a second encoder model checkpoint is stored for the encoder model after the pre-training procedure is executed; and
the second encoder model checkpoint can be accessed, via the API, as a basis for performing a plurality of different supervised training procedures.

18. The method of claim 11, wherein:
the SSL abstraction model can permit a user to indicate user-specified input parameters for training multiple encoder models.

19. The method of claim 18, wherein:
each of the multiple encoder models are trained using the pre-training procedure and the supervised training procedure; and
a plurality of encoder model checkpoints are stored, each of which is associated with a respective one of the multiple encoder models.

20. The method of claim 11, wherein:
the one or more AI functions are configured to analyze images pertaining to items offered through an electronic platform; and
the one or more AI functions perform one or more classification functions that are utilized to supplement metadata associated with the items offered through an electronic platform.
